(19) United States
(12) Patent Application Publication
(10) Pub. No.: US 2022/0255770 A1
(43) Pub. Date: Aug. 11, 2022

(54) SYSTEM AND METHOD FOR EXCHANGING DATA BETWEEN CONTROL OR EVALUATION APPARATUSES AND DATA-PRODUCING DEVICES, MORE PARTICULARLY TOOLS, NETWORK-CAPABLE MODULE AND TOOL HAVING A NETWORK-CAPABLE MODULE

(71) Applicant: STAHLWILLE Eduard Wille GmbH & Co. KG, Wuppertal (DE)

(72) Inventors: David Schoenen, Wuppertal (DE); Timo Schmidt, Wuppertal (DE)

(73) Assignee: STAHLWILLE Eduard Wille GmbH & Co. KG, Wuppertal (DE)

(21) Appl. No.: 17/434,310

(22) PCT Filed: Feb. 21, 2020
(86) PCT No.: PCT/EP2020/054678

§ 371 Date: Aug. 26, 2021

(30) Foreign Application Priority Data
Feb. 28, 2019 (DE) 10 2019 105 099.5

(51) Int. Cl. H04L 12/46; G05B 19/418; H04L 61/5007; H04W 76/10

(52) U.S. Cl. CPC H04L 12/4633; G05B 19/4185; H04L 61/5007; G16Y 40/30; G05B 2219/15117; G05B 2219/25274; H04W 76/10

(57) ABSTRACT

A system for exchanging data between control or evaluation apparatuses and data- producing devices, such as tools, testing installations, calibrating installations or appliances for automatic identification is proposed, wherein the system comprises a control or evaluation apparatus and at least one network-capable module which can be connected or is connected to a data-producing device, wherein the control or evaluation apparatus and the network-capable module are designed to exchange data via a wireless data link, wherein, in a first operating mode, a communication protocol provided for exchanging data between the control or evaluation apparatus and the data-producing device is tunneled via the wireless data link.

The present invention relates to a system for exchanging data between control and evaluation apparatuses and data-producing devices such as tools, testing installations, calibrating installations or appliances for automatic identification, comprising a control or evaluation apparatus and at least one network-capable module which can be connected or is connected to a data-producing device. The present invention further relates to a network-capable module, a tool having a network-capable module, and a method for exchanging data between a control or evaluation apparatus and data-producing devices.

### TECHNOLOGICAL BACKGROUND

Data-producing devices, such as tools, in particular torque wrenches, torque screwdrivers, testing or calibrating installations, but also RFID reading stations or barcode scanners, often communicate with control or evaluation apparatuses in an industrial environment in a wired manner via proprietary and individual protocol structures or communication protocols.

EP 1 902 817 A2 discloses a wireless power tool, wherein the wireless power tool comprises a wireless transmission apparatus for transmitting data, parameters or the like between the power tool and a higher-level control unit. The transmission apparatus has a module adapter detachably arranged on the power tool and a replaceable radio module. The module adapter is used to arrange various replaceable radio modules. The radio module can be a WLAN module.

From DE 10 2011 108 963 A1, an industrial and electrically driven tool with two independent radio modules is known, so that a redundant communication link can be established with a controller. By means of a data interface, the tool can be controlled remotely using an access point.

EP 3 115 860 A1 discloses a tool system having a display in graphical form for an assembly installation. Here, the tool system and a display apparatus are connected to each other via the Internet.

To increase flexibility in everyday work, the aim is to intensify wireless data exchange to the point of real-time communication. In this connection, radio standards in the sub-GHz range are often used. For these radio standards, the existing communication protocols usually have to be adapted to new protocol layers.

### DESCRIPTION OF THE INVENTION: OBJECT, SOLUTION, ADVANTAGES

The underlying object of the present invention is to provide a system for exchanging data between control or evaluation apparatuses and data-producing devices, such as tools, testing installations, calibrating installations or appliances for automatic identification, with which the data-producing devices can be integrated into a standardized radio topology without adaptation effort. Furthermore, it is an object of the present invention to provide a network-capable module, a tool having a network-capable module and a method for exchanging data between control or evaluation apparatuses and data-producing devices, with which the aforementioned advantages are achieved.

To achieve the object underlying the invention, a system for exchanging data between control or evaluation apparatuses and data-producing devices, such as tools, testing installations, calibrating installations or appliances for automatic identification, is proposed, the system comprising a control or evaluation apparatus and at least one network-capable module which can be connected or is connected to a data-producing device, wherein the control or evaluation apparatus and the network-capable module are designed to exchange data via a wireless data link, wherein in a first operating mode, a communication protocol provided for exchanging data between the control or evaluation apparatus and the data-producing device is tunneled via the wireless data link.

The data-producing devices can be designed as tools, testing installations, calibrating installations or as appliances for automatic identification. Further, the data-producing devices can be RFID reading stations or barcode scanners. In addition, the data-producing device can be a mobile device, such as a tool, or a stationary device, such as a testing appliance or testing installation.

The control or evaluation apparatus can be a computing unit, for example a personal computer, or an otherwise configured controlling or evaluating system, which preferably receives and evaluates data from the data-producing device or sends control commands or other data to the data-producing device.

The network-capable module and the control or evaluation apparatus are designed to exchange data via a wireless data link. In doing so, the control or evaluation apparatus and the network-capable module can use an existing wireless data link or establish a wireless data link. The data transmission does not have to be wireless over the entire transmission path. Thus, it is also possible for the network-capable module to be connected to a first transmitting and receiving device via a wireless data link, wherein the first transmitting and receiving device has a wireless or wired Internet connection, so that part of the transmission path can also take place in a wired manner via the Internet. Furthermore, a second transmitting and receiving device connected to the Internet can be provided, which is connected to the control or evaluation apparatus via a further wireless data link.

The network-capable module can further be connected to the data-producing device via a wireless or wired data link in order to forward data from the control or evaluation apparatus to the data-producing device or to receive data from the data-producing devices and forward it to the control or evaluation apparatus via the wireless data connection.

An essential feature of the data exchange system according to the invention is that, in a first operating mode, a communication protocol provided for exchanging data between the control or evaluation apparatus and the data-producing devices is tunneled via the wireless data link.

In a network, tunneling refers to the transmission of a communication protocol that is embedded in another communication protocol for transport. The control or evaluation apparatuses and the data-producing devices preferably use a specific and, if necessary, proprietary communication protocol provided for data exchange. In the prior art, this provided communication protocol must be adapted to the network protocol used for data transmission between the data-producing devices and the control and evaluation apparatuses.

According to the present invention, however, the communication protocol provided between the data-producing device and the control or evaluation apparatus is embedded into the network protocol used for data transmission, in particular in the network protocol used for the wireless data link, without the need to adapt the data to be exchanged to the network protocol.

In other words, the data-producing device and the control and evaluation apparatus communicate upstream and downstream of the wireless data link using the originally provided communication protocol. The data-producing device and the control or evaluation apparatus are thus decoupled from the network protocol used for the wireless data link. Thus, unlike known in the prior art, the already implemented and provided communication protocols, for example a USB protocol, can be adopted unchanged.

Using a tunneling method results in the advantage of increased flexibility in everyday work and a simplified adaptation effort for data exchange, even within the scope of a real-time communication.

By tunneling the provided communication protocol via the wireless data link, the system according to the invention provides a so-called “plug-and-use” solution, by which wireless communication between data-producing devices and control or evaluation apparatuses can take place without complicated adaptation of the communication protocols.

Preferably, the data-producing device is a torque wrench, a torque screwdriver, a testing installation, in particular a testing appliance, or a calibrating installation, in particular a calibrating apparatus or a calibrating appliance.

Thus, the system can be used particularly advantageously with tools used in an industrial environment. In particular, the system offers advantages when the data-producing device is configured as a torque wrench or torque screwdriver, since a multiplicity of such tools is usually used simultaneously, so that the plug-and-use solution provided improves flexibility and workflows in a particularly positive way.

Since the network-capable module is connected or can be connected to the data-producing device, it can in particular be designed as a separate module. Thus, this results in a modular system into which further or more data-producing devices can be easily integrated using further network-capable modules.

With particular advantage, it is provided that the wireless data link uses the Internet Protocol (TCP/IP), and/or that the network-capable module can be connected or is connected to the data-producing device via a USB connection.

The communication protocol provided for exchanging data between the control or evaluation apparatus and the data-producing device is thus tunneled in particular via the Internet Protocol. This facilitates, with particular advantage, a data exchange which takes place at least in part via the Internet. By connecting the network-capable module to the data-producing device by means of a USB connection, a particularly high degree of flexibility is provided. Moreover, with particular advantage, the USB protocol is tunneled via the Internet Protocol.

Furthermore, it can preferably be provided that in a second operating mode, the network-capable module generates a hotspot, in particular a WLAN hotspot.

The provision of a hotspot in the second operating mode by the network-capable module enables the integration of further devices, such as notebooks or laptops, into the system. The network-capable module performs an access point function in the second operating mode.

Preferably, it can therefore be provided that a further device, in particular a further network-capable module, a mobile terminal or a computing unit, in particular a notebook or a laptop, can be integrated or is integrated into the system via the hotspot.

Thus, further network-capable modules can be integrated into the system via the network-capable module for exchanging data with the control or evaluation unit. In addition, a direct connection from the network-capable module to a further device, such as a mobile terminal, for example a tablet, or a computing unit, in particular a laptop or a notebook, can also be provided.

With further advantage, it is provided that the network-capable module is assigned a unique address, in particular a unique IP address, statically or dynamically, preferably via DHCP.

Thus, the module preferably becomes part of a fixed network and can be uniquely addressed and activated therefrom.

Preferably, it is provided that the data-producing device is connected to the Internet via the wireless data link and, if applicable, a transmitting and receiving unit, and/or that the data-producing device is connected to an “Internet of Things” via the wireless data link, with the network-capable module preferably identifying the data-producing device with respect to the Internet of Things.

The connection to the Internet provides a decentralized structure for the system. In particular, the data-producing device and the control or evaluation devices can be arranged spatially separated far away from each other.

It can be provided that a data-producing device integrated into the system acts as a USB hub or smart hub and is preferably designed for connecting further terminal devices or data-producing devices.

Furthermore, it can be provided that the control or evaluation apparatus is designed to execute client software and/or that the control or evaluation apparatus is designed to recognize network-capable modules connected via the wireless data link.

In particular, client software can be provided on the control or evaluation apparatus for tunneling the provided communication protocol via the network protocol, in particular the Internet Protocol, of the wireless data link. The client software is preferably designed to pack the provided communication protocol into data packets of the network protocol, for example the Internet Protocol, and to unpack them.

Furthermore, the control or evaluation apparatus is designed to automatically recognize network-capable modules connected via the wireless data link.

A further solution to the object underlying the invention is to provide a network-capable module for a system described above.

The network-capable module can be designed according to the configurations of the pre-described system and can have the features provided for executing the functions performed by the system.

Preferably, the networkable module comprises a printed circuit board, wherein at least one central processing unit (CPU), one WLAN chip and one WLAN antenna are arranged on the printed circuit board.

By integrating the CPU, the WLAN chip and the WLAN antenna on the printed circuit board, the components are arranged in as small a space as possible, so that the network-capable module can have a particularly compact design.

More preferably, it is provided that the printed circuit board comprises a USB interface and preferably an FTDI chip. An FTDI chip is an interface chip that enables a serial interface to be made available via USB.

The data-producing device can be connected to the network-capable module via a USB port, optionally using an FTDI chip, so that data from the data-producing device can be tunneled via the wireless data link and transmitted to the control or evaluation apparatus.

With further advantage, it can be provided that the module has an energy storage, in particular a battery or an accumulator, or a connection for an external energy supply, in particular by a data-producing device, or for a power supply unit.

Thus, the power supply to the network-capable module can be provided either by an integrated energy storage device or by an external power supply. In the case of an external power supply, electrical power can be provided by the data-producing device, for example via a USB connection. Alternatively, it is possible that the network-capable module is connected to a power supply via a power supply unit.

Preferably, it can be provided that the module has a switch for switching on, or that the module is triggered by a data-producing device connected to the module.

In particular, the module can be designed such that when the data-producing device, in particular the tool, is switched on, the module is also switched on by being triggered by the data-producing device. In this case, the network-capable module does not have to be switched on independently of the data-producing device.

The previously described system for exchanging data can include a previously described network-capable module.

A further solution to the problem underlying the invention is to provide a tool having a previously described networkable module.

Yet another solution to the object underlying the invention is to provide a method for exchanging data between control or evaluation apparatuses and data-producing devices such as tools, testing installations, calibrating installations or appliances for automatic identification, wherein at least one network-capable module is connected to a data-producing device, wherein a wireless data link is established between the network-capable module and a control or evaluation apparatus, wherein further, in a first operating mode, a communication protocol provided for communication between the control or evaluation apparatus and the data-producing device is tunneled via the wireless data link.

The method can be applied in particular using a previously described system for data exchange. The advantages, features and configurations described for the previously described system, network-capable module and tool can also be applied analogically to the method according to the invention.

### BRIEF DESCRIPTION OF THE FIGURES

The invention is explained in more detail with reference to the figures. In the figures

FIG. 1 shows a system for exchanging data between prior art control or evaluation apparatuses and data-producing devices, and

FIG. 2 shows a system for exchanging data between control or evaluation apparatuses and data-producing devices in accordance with the invention.

### DETAILED DESCRIPTION OF THE FIGURES

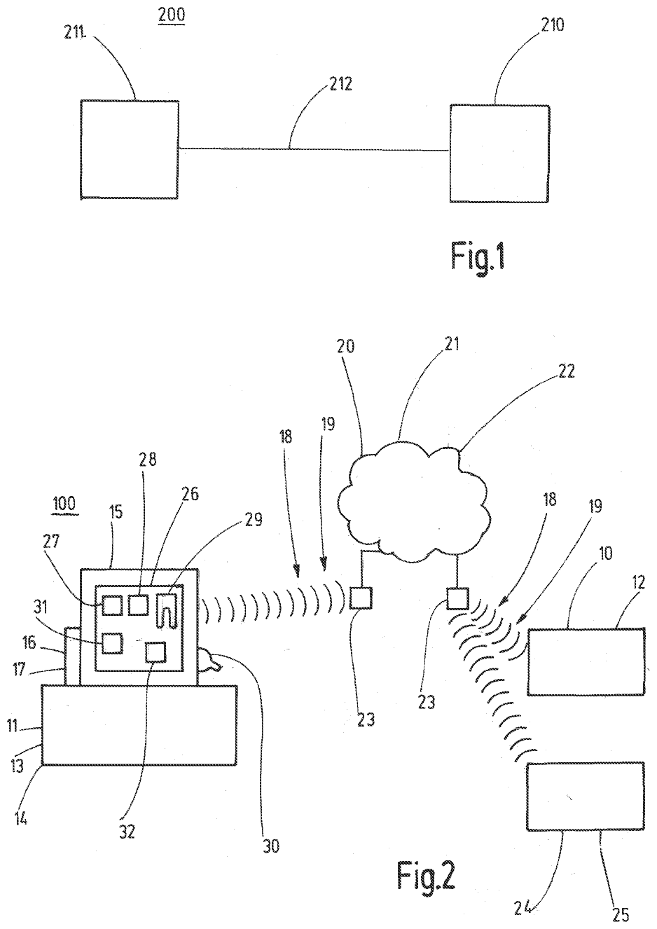

FIG. 1 shows a known system 200 for exchanging data between a control or evaluation apparatus 210 and a data-producing device 211. The data-producing device 211 is connected to the control or evaluation apparatus 210 via a cable 212. In the known system 200, the communication protocol provided for exchanging data between the control or evaluation apparatus 210 and the data-producing device 211 must be converted into a network protocol provided for transmitting data via the cable 212.

FIG. 2 shows a system 100 for exchanging data between a control or evaluation apparatus 10 and a data-producing device 11. The control or evaluation apparatus 10 is designed as a personal computer 12 on which client software is executed. The data-producing device 11 is designed as a tool 13, in particular as a torque wrench 14. A network-capable module 15 is connected to the data-producing device 11 via a cable connection 16, wherein the cable connection 16 can be configured as a USB connection 17. The network-capable module 15 and the control or evaluation apparatus 10 are designed to establish a wireless data link 18, wherein the wireless data link 18 is designed as a WLAN connection 19. The network-capable module 15 receives data from the data-producing device 11 and transmits it via the WLAN connection 19 to the control or evaluation apparatus 10, which is designed as a personal computer 12. Likewise, control commands, for example, are transmitted from the control or evaluation apparatus 10 to the data-producing device 11 via the WLAN connection 19. In this case, the wireless data link 18 is not provided over the entire transmission path between the data-producing device 11 and the control or evaluation apparatus. Part of the transmission path can also be via a network 20, or via the Internet 21 or cloud services 22. Transmitting and receiving devices 23 can be provided for the transition from the wireless data link 18 to the network.

The wireless data link 18, or WLAN connection 19, uses the Internet Protocol. This has the advantage that the data packets to be transmitted can be transmitted via the Internet 21 without any further conversion effort for part of the transmission path. Furthermore, for the data exchange between the data-producing device 11 and the control or evaluation apparatus 10, a communication protocol provided for this purpose, which may be proprietary, is used. The communication protocol is tunneled through the Internet Protocol, so that the communication protocol does not need to be converted to the Internet Protocol. In other words, data to be transmitted using the communication protocol is embedded into the Internet Protocol along with the communication protocol. The data-producing device 11 and control or evaluation programs executed on the control or evaluation apparatus 10 get to see only the provided communication protocol and are shielded from the technical characteristics of the Internet Protocol.

A mobile terminal 24 can be integrated into the system 100. The mobile terminal 24 can be, for example, a notebook computer or a laptop computer 25. Client software executed on the personal computer 12 enables the network-capable module 15 integrated into the system 100 via the wireless data link 18 and the mobile terminal device 24 to be recognized and to control the exchange of data within the system 100. Furthermore, the data-producing device 11 and/or the tool 13 and/or the mobile terminal 24 can be connected to an “Internet of Things”.

The network-capable module 15 comprises a printed circuit board 26 on which a CPU 27, a WLAN chip 28 and a WLAN antenna 29 are arranged.

The network-capable module 15 is connected to the data-producing device 11 via the cable connection 16 and is supplied with power by the data-producing device 11. To switch on the network-capable module 15, it is triggered by the data-producing device 11. Alternatively or additionally, a switch 30 can be provided for switching on the network-capable module 15. Furthermore, an FTDI chip 31 can be disposed on the printed circuit board 26 of the network-capable module 15. Alternatively or additionally, a battery 32 can be disposed on the printed circuit board.

In addition, the network-capable module 15 can generate a WLAN hotspot via which further mobile terminal devices can be integrated into the system 100.

1. A system for exchanging data between control or evaluation apparatuses and data-producing devices, such as tools, testing installations, calibrating installations or appliances for automatic identification, comprising a control or evaluation apparatus and at least one network-capable module which can be connected or is connected to a data-producing device, wherein the control or evaluation apparatus and the network-capable module are designed to exchange data via a wireless data link, characterized in that, in a first operating mode, a communication protocol provided for exchanging data between the control or evaluation apparatus and the data-producing device is tunneled via the wireless data link.

2. The system according to claim 1, characterized in that the data-producing device is a torque wrench, a torque screwdriver, a testing installation or a calibrating installation.

3. The system according to claim 1, characterized in that the wireless data link uses the Internet Protocol(TCP/IP), and/or that the network-capable module can be connected or is connected to the data-producing device via a USB connection.

4. The system according to claim 1, characterized in that in a second operating mode, the network-capable module generates a hotspot, in particular a WLAN hotspot.

5. The system according to claim 4, characterized in that at least one further device, in particular a further network-capable module, a mobile terminal or a computing unit, in particular a laptop, can be integrated or is integrated into the system via the hotspot.

6. The system according to claim 1, characterized in that the network-capable module is assigned a unique address, in particular a unique IP address, statically or dynamically, preferably via DHCP.

7. The system according to claim 1, characterized in that the data-producing device is connected to the Internet via the wireless data link, and/or that the data-producing device is connected to an Internet of Things via the wireless data link, wherein preferably the network-capable module identifies the data-producing device with respect to the Internet of Things.

8. The system according to claim 1, characterized in that the control or evaluation apparatus is designed to execute client software and/or that the control or evaluation apparatus is designed to recognize network-capable modules connected via the wireless data link.

9. A network-capable module for a system according to claim 8.

10. The network-capable module according to claim 9, characterized in that the module comprises a printed circuit board, wherein at least one CPU, one WLAN chip and one WLAN antenna are arranged on the printed circuit board.

11. The network-capable module according to claim 10, characterized in that the printed circuit board comprises a USB interface.

12. The network-capable module according to claim 9, characterized in that the module has an energy storage, in particular a battery or an accumulator, or a connection for an external power supply, in particular by a data-producing device, or for a power supply unit.

13. The network-capable module according to claim 9, characterized in that the module has a switch for switching on, and/or that the module is triggered by a data-producing device connected to the module.

14. A tool with a network-capable module according to claim 9.

15. A method for exchanging data between control or evaluation apparatuses and data-producing devices, such as tools, testing installations, calibrating installations or appliances for automatic identification, wherein at least one network-capable module is connected to a data-producing device, wherein a wireless data link is established between the network-capable module and a control or evaluation apparatus, characterized in that, in a first operating mode, a communication protocol provided for communication between the control or evaluation apparatus and the data-producing device is tunneled via the wireless data link.
